(19) United States
(12) Patent Application Publication
(10) Pub. No.: US 2026/0274012 A1
(43) Pub. Date: Sep. 17, 2026

(54) AIRCRAFT TIRE CARCASS REINFORCEMENTS

(71) Applicant: COMPAGNIE GENERALE DES ETABLISSEMENTS MICHELIN, Clermont-Ferrand (FR)

(72) Inventor: HERVE FERIGO, Clermont-Ferrand (FR)

(21) Appl. No.: 19/469,242

(22) PCT Filed: Mar. 25, 2024
(86) PCT No.: PCT/EP2024/057964

§ 371 Date: Sep. 25, 2025

(30) Foreign Application Priority Data
Mar. 29, 2023 (FR) FR2303017

(51) Int. Cl. B60C 15/00; B60C 11/03; B60C 15/06

(52) U.S. Cl. CPC B60C 15/0036; B60C 15/0628; B60C 2011/0341; B60C 2200/02

(57) ABSTRACT

The radial tire for an aircraft, has at least one carcass layer (51) having reinforcing elements, each carcass layer (51) having a first, main part (52) that connects one bead wire to the other and is connected at its ends to two other parts or turn-ups (53) that each have a free end (531). The free ends (531) of the two turn-ups (53) of at least one carcass layer (52) are positioned axially so as to form a covering (6) between the two axially outer walls (2112) of the two axially outermost furrows (211) of the tread, each covering having an axial width (L) less than one third of the axial width (L1) of the crown reinforcement.

The present invention relates to an aircraft tyre having a radial carcass reinforcement.

Aircraft tyres are intended to bear heavy loads and to be inflated to relatively high pressures at least above 8 bar, preferably above 10 bar, and potentially ranging up to 25 bar.

The tyres in question have rims with a diameter at least equal to 6 inches, but preferably at least equal to 20 inches. Aircraft tyres are also characterized by their high load and their deflection under nominal pressure and load, which reaches 28% to 33% for civil aircraft and up to 50% for military aircraft. Aircraft are vehicles in which the landing gear is not directional; the aircraft in flight or when taxiing is directed by the manipulation of flaps on the wings or of the rear vertical stabilizer of the aircraft and not by the rotation of the tyres, as is the case for road vehicles. Aircraft tyres therefore have a very specific architecture both for their carcasses, which need to withstand a very high burst pressure, and their crown reinforcements made up of bi-layers based on spiral strips devoid of free ends at their axial ends, as shown by the document EP 2499006 B1 .

Since a tyre has a geometry of revolution about an axis of rotation, the geometry of the tyre is generally described in a meridian plane containing the axis of rotation of the tyre. For a given meridian plane, the radial, axial and circumferential directions denote the directions perpendicular to the axis of rotation of the tyre, parallel to the axis of rotation of the tyre and perpendicular to the meridian plane, respectively. The circumferential direction is tangential to the circumference.

In the following text, the expressions “radially inner/radially on the inside” and “radially outer/radially on the outside” mean “closer to” and “further away from the axis of rotation of the tyre”, respectively. “Axially inner/axially on the inside” and “axially outer/axially on the outside” mean “closer to” and “further away from the equatorial plane of the tyre”, respectively, the equatorial plane of the tyre being the plane that passes through the middle of the tread surface and is perpendicular to the axis of rotation.

An aircraft tyre according to the invention has a tread comprising at least 2 longitudinal furrows, each furrow having an axially inner wall and an axially outer wall, two, axially outermost furrows being situated on either side of the equatorial plane. Usually, to avoid unnecessary stresses when mounting on the rim, one radially outermost furrow is symmetric with another radially outermost furrow with respect to the equatorial plane. The furrows have the function of evacuating any water that may be situated on the runway so as to ensure proper grip for the tyre.

An aircraft tyre according to the invention also has a crown reinforcement comprising working layers having textile reinforcing elements, made of aliphatic polyamide or hybrid polyamide consisting of aliphatic polyamide and aromatic polyamide, which are coated in rubber compounds and form a variable angle with the longitudinal direction XX′, the absolute value of which is between 0 and 45°. A working layer is usually obtained by zigzag circumferential winding or circumferential winding in turns of a strip on a cylindrical laying surface having as its axis of revolution the axis of rotation of the tyre. The strip is generally made up of at least one continuous textile reinforcer coated in an elastomeric compound and, usually, of a juxtaposition of mutually parallel continuous textile reinforcers coated in an elastomeric compound. The advantage of having zigzag circumferential winding or circumferential winding in turns is that, at the axial ends of the working layers, it avoids there being free ends of reinforcers liable to generate cracks in these zones and therefore to reduce the endurance of the working reinforcement and the life of the tyre. While a strip is being wound circumferentially in a zigzag, the working layers are laid in pairs, each pair of working layers constituting a working bi-layer. Thus, a working bi-layer is made up, away from its axial ends, of two radially superposed working layers. At its axial ends, a working bi-layer generally comprises more than two radially superposed working layers. The number of additional working layers, in the radial direction, compared with the two working layers of the main section of the working bi-layer are referred to as the axial end overthickness. Thus, the number of bi-layers is determined on a meridian cross section on the equatorial plane.

An aircraft tyre according to the invention also has a radial carcass reinforcement, this radial carcass reinforcement comprising carcass layers comprising a plurality of textile reinforcing elements oriented substantially radially (i.e. making an angle of between 75° and 105° with the circumferential direction), this reinforcement being anchored to at least one circumferential reinforcement in each bead, and usually to a single circumferential reinforcement known as a bead wire. According to the prior art, the reinforcing elements of said carcass layers are wound around said bead wire from the inside to the outside or vice versa, forming turn-ups, the respective ends of which are spaced apart radially from the axis of rotation of the tyre. The reinforcing elements are coated in a rubber compound known as a skim compound.

Each carcass layer has a first, main part or outward strand, connecting one bead wire to the other, and two parts or turn-ups that each have a free end. A free end is understood to mean only that this end is not connected to another part of the carcass layer. Each end of the first part of each carcass layer is connected to one or the other of the turn-ups having a free end, and therefore neither of its ends is free. One of the ends of each turn-up is connected to the first part, known as the main part, under the bead wire, the other end being free.

For short turn-ups, it is possible for the two turn-ups that each have a free end to be axially on the inside of the first part of the carcass layer. The first, main part of the carcass layer has the function of maintaining the internal pressure by absorbing the tensions, in particular radial tensions, of the sidewall. The key role of the turn-ups is to prevent the unwinding of the carcass layer by shearing of the skim compounds between the reinforcing layers of the carcass layers. Unwinding means that the carcass layer detaches from the bead wire under the effect of the internal pressure of the tyre.

The harsh conditions in which aircraft tyres are used are such that the endurance of the beads is worthy of improvement, particularly at the carcass-reinforcement turn-ups.

However, the endurance of aircraft tyre beads needs to be improved, because said beads experience substantial overload with compression of the radial height of the tyre of around 50% or more. Furthermore, the required number of carcass layers, generally formed of reinforcing elements made of aliphatic polyamide or composite, i.e. formed of filament yarns with different modulus values, is determined in order to withstand the tension caused by what is known as the proof pressure, which is equal to four times the service pressure. The significant number of said carcass layers obviously leads to a proliferation of reinforcing-element free ends, to a proliferation of inter-layer interfaces, to greater hysteresis losses and therefore to higher operating temperatures, all of these being factors that tend to increase bead fatigue and limit bead endurance.

Solutions using composite cords have notably been set out in the patent EP1381525, particularly composites formed of at least two filament yarns of high elastic modulus and of a single filament yarn of low elastic modulus, more specifically of two filament yarns made of aromatic polyamide or aramid, and of one filament yarn made of aliphatic polyamide (more specifically nylon).

However, the architecture described in the prior art is not optimal, particularly as regards two performance aspects essential to aircraft tyres, namely endurance and mass. The inventors have set themselves the objective of improving these performance aspects.

This improvement has been achieved by an aircraft tyre intended to be inflated to a pressure at least equal to 8 bar, having a crown comprising a tread and a crown reinforcement radially on the inside of the tread, two beads that are able to keep the tyre on a mounting rim, two sidewalls between the beads and the crown, and a radial carcass reinforcement providing the connection between the beads, the sidewalls and the crown,
an equatorial plane of the tyre being the plane passing through the middle of the tread and perpendicular to the axis of rotation,
the tread comprising at least 2 longitudinal furrows, two, axially outermost furrows being situated on either side of the equatorial plane, each furrow having an axially inner wall and an axially outer wall,
the radial carcass reinforcement having at least one carcass layer having reinforcing elements that are coated with rubber compounds and oriented substantially radially, i.e. forming an angle of between 75° and 105° with the circumferential direction,
each carcass layer being anchored at at least one circumferential reinforcement or bead wire in each bead, each carcass layer having a first, main part that connects one bead wire to the other and is connected at its ends to two other parts or turn-ups that each have a free end,
the crown reinforcement comprising at least 1 pair of working layers having reinforcing elements that are coated with rubber compounds and form a variable angle with the longitudinal direction XX′, the absolute value of which is between 0 and 45°, having an axial width,
the free ends of the two turn-ups of at least one carcass layer being positioned axially between the two axially outer walls of the two axially outermost furrows, a free end of one turn-up being radially on the outside of the second free end of the other turn-up of the carcass layer in question and being positioned axially with respect to the radially inner free end so as to form a covering of the two free ends of the two turn-ups of said carcass layer,
each covering of two turn-ups of a carcass layer having an axial width less than one third of the axial width of the crown reinforcement.

Specifically, bead optimization astonishingly does not consist in looking for reinforcing elements that have good fatigue resistance and the highest possible force at break for the lowest possible mass of reinforcement. A surprising way of greatly reducing stresses in the bottom zone and in particular the compressing of certain carcass layers, is to eliminate the presences of the free ends of the carcass layers in the bead. It is even less relevant to have these free ends in the sidewall, which is the zone of maximum deformation and bending of the tyre when running on flat ground. An optimum zone for disposing the ends of the turn-ups of the carcass layers is under the tread in the zone in which the working layers absorb a major part of the pressure, namely between the furrows and more specifically between the two axially outer walls of the two axially outermost furrows, these two furrows being situated on either side of the equatorial plane. This arrangement that makes it possible to eliminate a carcass layer end in each bead for at least one carcass layer makes it possible to reduce the compression in the bead of the first parts of the carcass layers.

In order to lighten the tyre by reducing the number of carcass layers, it is vital to recouple the free ends of the carcass layers to one another in order that this recoupled part, or covering, avoids the unwinding of the carcass layers by shearing of their skim compounds. If there is no recoupling, it is necessary to provide another layer for recoupling with reinforcing elements close to the angles of the carcass layers, namely between 75 and 105°. On account of their angles, the crown layers are unable to absorb transverse forces.

Thus, for a good endurance performance and for the optimal improvement of the invention, it is necessary to have a covering of the two turn-ups under the crown between the axially outermost furrows of the tread, and more specifically between their two axially outer walls. Covering is understood to mean that a part of one turn-up is pressed against a part of the other turn-up, the radial distance between the two turn-ups, between the centres of the reinforcing elements of the two turn-ups, being less than the sum of the diameters of a reinforcing element of each turn-up, preferably less than 1.5 times the average of the diameters of a reinforcing element of each turn-up. The covering makes it possible to transfer the forces applied to one of the turn-ups to the other turn-up, namely to recouple the two turn-ups.

To allow an effective saving of mass, each covering of two turn-ups of a carcass layer has an axial width less than one third of the axial width of the crown reinforcement, advantageously an axial width less than one quarter of the width of the crown reinforcement. The axial width of the covering or of the crown reinforcement may be measured for example on a meridian cross section of the tyre.

Each covering of two turn-ups of a carcass layer has an axial width at least equal to 30 mm and at most 100 mm. Starting from 30 mm, the covering is already along a length that allows excellent recoupling. Beyond 100 mm, the covering may be shortened in order to be optimal from a mass point of view.

Advantageously, the free ends of the two turn-ups of each carcass layer are positioned axially between the two axially outer walls of the two axially outermost furrows. The advantage of disposing all the free ends of the carcass layers under the crown and not in the bead or the sidewalls is that of reducing the variations in tension in the carcass layers at these ends. With their free ends positioned in this way, it is possible to have all the carcass layers under tension at the bead, this being extremely favourable for endurance. According to the usual design criteria, it is thus possible to reduce the number of carcass layers in the tyre for the same endurance and thus to save mass, this being extremely advantageous for aircraft tyres.

Preferably, each covering of two turn-ups of a carcass layer is positioned in line with a furrow of the tread. The expression “in line with” means “radially on the inside at least within the boundaries of the axial coordinates delimited by”. Thus, “the covering is in line with a furrow” means that, in each meridian cross section, the covering is radially on the inside of the furrow at least at the axial coordinates delimited by the furrow. The advantage of situating the covering in line with a furrow is that of ensuring better endurance performance of the covering. This is because, being in line with the furrow, the covering benefits from a higher pressure during the curing of the tyre and also from better curing, the supply of heat and pressure by the mould being higher at this point of the tyre, under the raised element of the mould which creates the furrow.

Advantageously, for a tyre comprising at least 2 carcass layers, the carcass layers are different in terms of nature, or in terms of properties of the reinforcing elements of the two carcass layers, or in terms of spacing between the reinforcing elements. In this type of architecture, it is possible, in order to further optimize the mass or endurance, to destandardize the carcass layers in terms of distance between the reinforcing elements, or in terms of properties by altering, for example, the torsion of the threads of the reinforcing elements, or in terms of the nature of the reinforcing elements with one carcass layer made or not made of hybrid textile and the other with a different hybrid or nylon or aramid. Thus, advantageously, for a tyre comprising at least 2 carcass layers, the carcass layers are different in terms of hybrid or single-material nature of the reinforcing elements, or in terms of materials used, or in terms of properties of the reinforcing elements of the two carcass layers, or in terms of spacing between the reinforcing elements.

Preferably, for advantages of ease of manufacture, for a tyre comprising at least 2 carcass layers, the carcass layers are standardized in terms of all their characteristics, i.e. in terms of hybrid or single-material nature of the reinforcing elements, in terms of properties of the reinforcing elements of the two carcass layers, and in terms of spacing between the reinforcing elements.

Advantageously, for better absorption of the transverse forces transmitted by the tread to the architecture of the tyre, the crown reinforcement is radially on the outside of the carcass reinforcement.

Advantageously, the reinforcing elements of the carcass layers are textile reinforcing elements having a force at break at least equal to 35 daN. The force at break FR is measured according to standard D885/D885M—10A (2014).

A textile reinforcing element may be a textile elementary monofilament optionally coated with one or more layers of a coating based on a non-metallic adhesive composition.

This textile elementary monofilament is obtained, for example, by melt spinning, solution spinning or gel spinning. Each textile elementary monofilament is made from an organic material, in particular a polymer material, or an inorganic material, for example glass or carbon. The polymer materials may be of the thermoplastic type, for example aliphatic polyamides, in particular polyamides 6,6, aliphatic polyamides (more specifically nylon), and polyesters, in particular polyethylene terephthalate. The polymer materials can be of the non-thermoplastic type, for example aromatic polyamides, in particular aramid, and cellulose, either natural or synthetic, in particular rayon. Each textile elementary monofilament has a substantially circular cross section with a diameter ranging, for example, from 2 μm to 100 μm.

A textile reinforcing element may be an assembly of several textile elementary monofilaments as defined above, also called a strand. A strand comprises preferably more than 10 textile elementary monofilaments, preferably more than 100 textile elementary monofilaments and more preferably more than 500 textile elementary monofilaments.

A textile reinforcing element may also be an assembly of several strands as defined above. In a variant, the materials from which the textile elementary monofilaments of each strand are made are identical. In another variant, the materials from which the textile elementary monofilaments of each strand are made are different, the textile reinforcing element then commonly being known as a hybrid textile reinforcing element.

Advantageously, a tyre according to the invention may comprise, in the bead, at least one inner tongue between the bead wire and the closest carcass layer, comprising textile reinforcing elements that form an angle of between 45° and 135° with the circumferential direction XX′, the axially outermost free end of the tongue being radially lower than the height of the flange of the nominal rim. A tongue differs from a carcass layer in that a tongue does not have a first, main part connecting the two beads. It is generally positioned between the bead wire and the carcass layers. It may have the function of better distributing the shear forces between the bead wires and the carcass layers, protecting the carcass from impacts, or the like. In the invention, it is advantageous not to place the axially outermost end in the sidewall for the endurance of the latter. The dimension of the nominal rims of aircraft tyres is set by the Aircraft Year Book edited by the Tyre and Rim Association (TRA).

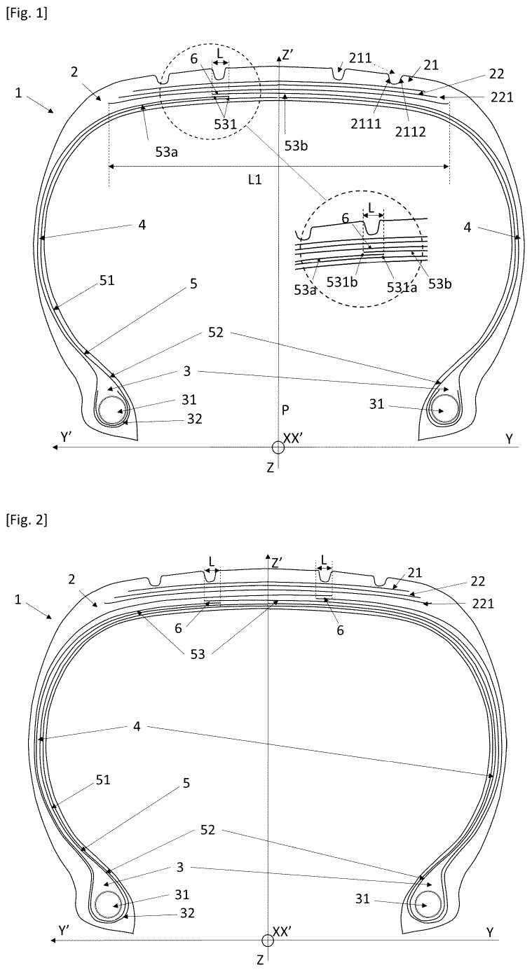

The features of the invention are illustrated in the schematic FIGS. 1 and 2, which are not depicted to scale, showing a meridian cross section through the tyre according to the invention.

In FIG. 1, the aircraft tyre (1) has a crown (2) comprising a tread (21) and a crown reinforcement (22) radially on the inside of the tread, two beads (3) that are able to keep the tyre on a mounting rim, two sidewalls (4) between the beads (3) and the crown (2), and a radial carcass reinforcement (5) providing the connection between the beads (3), the sidewalls (4) and the crown (2). The equatorial plane (P) of the tyre passes through the middle of the tread surface, perpendicularly to the axis (YY′) of rotation of the tyre. The tread (22) comprises 4 longitudinal furrows (211). Two, axially outermost furrows are situated on either side of the equatorial plane. Each furrow (211) has an axially inner wall (2111) and an axially outer wall (2112). The radial carcass reinforcement (5) has a carcass layer (51) anchored at a bead wire (31) in each bead (3), the carcass layer (51) having a first, main part (52) that connects one bead wire to the other and is connected at its ends to two turn-ups (53) that each have a free end (531). The free ends (531) of the two turn-ups (53) are positioned axially between the two axially outer walls (2112) of the two furrows (211). A free end (531) of the turn-ups (53) is radially on the outside of the second free end (531) of the other turn-up (53) and is positioned axially with respect to the radially inner free end (531) so as to form a covering (6) of axial length (L), positioned in line with a furrow (211) of the tread (21). The crown reinforcement (22) comprises 3 pairs of working layers (221) having textile reinforcing elements that form a variable angle of between 0 and 45° with the longitudinal direction XX′. The crown reinforcement has an axial length (L1) measured on the crown layer of greatest axial width. An inner tongue (32) is positioned between the bead wire (3) and the carcass layer (5) in order to better couple these two sub-elements of the tyre. It comprises two free ends, neither of which is positioned in the sidewall (3), each of them being positioned below the rim flange (not shown here). FIG. 1 comprises a close-up of the covering (6) which makes it easier to distinguish, at the covering 6, the two turn-ups 53a and 53b and their free ends 531a and 531b.

FIG. 2 illustrates the invention with a carcass reinforcement (5) comprising 2 carcass layers, wherein the free ends (531) of the turn-ups (53) are positioned under the crown (2) between the axially outermost walls (2112) of the two axially outermost furrows and have an axial covering (6) length (L). Each covering is positioned in line with a different furrow (211). This architecture can clearly be extended to 3 or more carcass layers.

The invention was tested on a tyre of standardized size 790×275 R 15. The Control tyre has a carcass reinforcement comprising 6 carcass layers, the ends of which are disposed regularly between the bottom and the top of the bead. The reinforcing elements are made of nylon with 3 twisted threads, the titre of which is equal to 188 tex each.

A tyre according to the invention was manufactured with 2 carcass layers, wherein the free ends of the turn-ups are positioned under the crown, forming a covering with an axial length of 40 mm and a width less than 25% of the axial width of the crown reinforcement, and positioned under a furrow of the tread. The lack of compression in the carcass layers made it possible to use hybrid reinforcement elements known as A330/A330/N188, namely 2 spun yarns of aramid of 330 tex each and one thread of nylon of 188 tex each, having a torsion of between 220 and 280 turns.

The crowns—tread and crown reinforcement—are identical between the control tyres and the tyres according to the invention.

The tyre was tested, with successful outcome, in accordance with standard TSO C62e which notably tests tyre endurance. The invention also passes the burst test or proof test at 4 times the nominal use pressure with a result improved by 12.5% compared with the control.

The tyre according to the invention makes it possible to lighten the mass by 2 kg compared with the control tyre, which, under these test criteria, satisfies a saving of close to 6% of the mass of the tyre.

1-9. (canceled)

10. An aircraft tire intended to be inflated to a pressure at least equal to 8 bar, having a crown comprising a tread and a crown reinforcement radially on an inside of the tread, two beads that are able to keep the tire on a mounting rim, two sidewalls between the two beads and the crown, and a radial carcass reinforcement providing a connection between the beads, the sidewalls and the crown,
an equatorial plane of the tire being a plane passing through a middle of the tread and perpendicular to an axis of rotation,
the tread comprising at least two longitudinal furrows, two axially outermost furrows being situated on either side of the equatorial plane, each axial outermost furrow having an axially inner wall and an axially outer wall,
the radial carcass reinforcement having at least one carcass layer having reinforcing elements that are coated with rubber compounds and oriented substantially radially,
each carcass layer being anchored at at least one circumferential reinforcement or bead wire in each bead, each carcass layer having a first main part that connects one bead wire to the other bead wire and is connected at ends to two other parts or turn-ups that each have a free end,
the crown reinforcement comprising at least one pair of working layers having reinforcing elements that are coated with rubber compounds and form a variable angle with a longitudinal direction, an absolute value of which is between 0 and 45°, having an axial width L1,
wherein the free ends of the two turn-ups of at least one carcass layer are positioned axially between the two axially outer walls of the two axially outermost furrows, a free end of one turn-up being radially on an outside of a second free end of the other turn-up of the carcass layer and being positioned axially with respect to the radially inner free end so as to form a covering of the two free ends of the two turn-ups of the carcass layer,
wherein each covering of two turn-ups of a carcass layer has an axial width L less than one third of the axial width L1 of the crown reinforcement, and
wherein each covering of two turn-ups of a carcass layer is positioned in line with a furrow of the tread.

11. The aircraft tire according to claim 10, wherein the free ends of the two turn-ups of each carcass layer are positioned axially between the two axially outer walls of the two axially outermost furrows.

12. The aircraft tire according to claim 10, wherein each covering of two turn-ups of a carcass layer has an axial width L at least equal to 30 mm and at most equal to 100 mm.

13. The aircraft tire according to claim 10, wherein further comprising at least two carcass layers, wherein the at least two carcass layers are different in terms of properties of the reinforcing elements of the two carcass layers or in terms of spacing between the reinforcing elements.

14. The aircraft tire according to claim 10, further comprising at least two carcass layers, wherein the at least two carcass layers are standardized with regard to features.

15. The aircraft tire according to claim 10, wherein the crown reinforcement is radially on an outside of the carcass reinforcement.

16. The aircraft tire according to claim 10, wherein the reinforcing elements of the carcass layers are textile reinforcing elements having a force at break at least equal to 35 daN.

17. The aircraft tire according to claim 10, further comprising, in the bead, at least one inner tongue between the bead wire and the closest carcass layer, comprising textile reinforcing elements that form an angle of between 45° and 135° with a circumferential direction, having two free ends, wherein an axially outermost free end of the tongue is radially lower than a height of the flange of the nominal rim.

18. The aircraft tire according to claim 10, wherein a nominal inflation pressure of the aircraft tire is at least equal to 10 bar.
